(19) United States
(12) Patent Application Publication
(10) Pub. No.: US 2023/0341830 A1
(43) Pub. Date: Oct. 26, 2023

(54) ENERGY EFFICIENT COMPUTATION SYSTEMS, NETWORKS, AND METHODS

(71) Applicant: Keith George Ferry, Burbank, CA (US)

(72) Inventor: Keith George Ferry, Burbank, CA (US)

(21) Appl. No.: 18/136,824

(22) Filed: Apr. 19, 2023

Related U.S. Application Data
(60) Provisional application No. 63/334,004, filed on Apr. 22, 2022.

(51) Int. Cl. G05B 19/042

(52) U.S. Cl. CPC G05B 19/042; G05B 2219/2639

(57) ABSTRACT

Networks, systems, and methods as disclosed herein include a parent system connected via data communication to one or more child systems, wherein the one or more child systems are located at a source of behind-the-meter (BTM) energy to perform a computational task assigned to the child system by the parent system using the BTM energy. The child system performs the computational task when the BTM energy available exceeds an amount for performing a primary task at the source of the BTM energy. The parent system may be located remote from the source of the BTM energy. The parent system may be at a source of BTM energy that may be the same or different as the source of BTM energy where the child system is located. The BTM energy may be provided by stationary and/or moving energy sources.

### CROSS-REFERENCE TO RELATED APPLICATIONS

The present application claims the benefit of U.S. Provisional Application No. 63/334,004 filed Apr. 22, 2022, which application is incorporated by reference in its entirety.

### TECHNICAL FIELD

Systems, networks, and methods as disclosed herein are used for performing computations or computational tasks and, more specifically, performing such computations or computational tasks in an energy efficient manner.

### BACKGROUND

It is well known that the growing carbon footprint of mankind poses an immediate threat of irreversibly devastating consequences for our planet. Renewable energy is a step towards reducing the carbon footprint but presents challenges as well even for established and efficient operations. One such challenge is that renewable energy cannot always be used at the time of generation. For example, energy generated behind-the-meter (BTM) by solar panels of a residential customer may exceed the customer's local demand. The customer traditionally could opt to store the excess energy in batteries which may then be used at a future time, particularly since the process of transmission of energy to another location had historically been extremely inefficient.

There have been improvements to the efficiency of transferring renewable energy. For example, in a network of electrical energy generation stations the AC voltage may be stepped up before leaving the source station. This process is done in varying ways depending on the distance of transmission, but also to support efficiency and stability of the electrical energy. With this improvement, recent projects have demonstrated utilizing the excess energy generated by renewable sources to be transmitted and utilized for other functions. For example Tesla solar roofs represent one example of a renewable energy method that supplies BTM energy at the source of installation (such as an individual residence), and still further captures energy to be submitted back into the greater electrical grid. The customer receives payment or credit on a bill for the contribution.

Unfortunately, these networks also face the challenge of balancing the input and output of energy as the supply and demand is not always a match. This has been done in a variety of ways including reducing the credit amount given to energy generators as disincentive, and even via curtailment; the reduction (typically involuntary) of output by a generator from what it otherwise could produce given available resources (e.g., wind and sunlight).

The process of curtailment is common in the energy generation sector as it has existed with fossil generation stations for some time. The impact of curtailment on a fossil station is notably less, as the generation station can simply adjust the fuel consumption to reduce energy output and proportionately reduce variable costs and maintain profitability. Conversely, a renewable energy generation station relies heavily on the availability of the particular resource (e.g., wind, solar, and the like), which may not align with the demand of energy at that time. Still further, the ability of the renewable energy station to ‘flex’ output based on curtailment restrictions results in operating inefficiencies while the facility is not fully operational.

As such, energy generation operations have implemented methods to capture and utilize excess energy at the time of availability. Such methods involve placement of equipment BTM located at the point of energy generation or another connected location, in either event the equipment is generally preceding the energy station's meter. With this method, an energy generation station can alternate the purpose of distribution between the meter and BTM operations to optimize costs and operations of the station. These operations can be traditional such as powering equipment for the facility or local charging stations. Alternatively, the BTM operations can be supportive of computational processes or tasks, such as Monte Carlo simulations, batch processing of financial transactions, graphics rendering, machine learning, neural network processing, queued operations, and oil and gas field simulation models, are good candidates for such interruptible computational operations.

Though efforts are being made with energy-efficiency improvements and renewable energy sources, these improvements can be years or decades away from availability. The financial demand for renewable energy opportunities have and will remain a hurdle for mass adoption. In addition, many ventures, though effective once realized, often require significant energy consumption for creation and deployment and thus create an ‘energy payback model’ wherein the venture initially represents further a burden to our planet. Meanwhile excess energy, as demonstrated by the aforementioned renewable energy generation stations, is ever present and widely available all around us from other sources such as vehicles.

Whether on land, sea or in the air, vehicles represent a necessary yet significant contributor to the growing carbon footprint of mankind. Simultaneously, vehicles are well known generators of excess energy but are widely untapped with a few exceptions. One such example that is well known though only recently commercialized with electric vehicles is regenerative braking. Wherein the energy captured from the vehicle braking represents roughly 30% of the total consumed energy, thus extending the range of the vehicle and contributing to a reduction of energy demand on the energy grid for charging the vehicle.

There have been other attempts to capture this and similar energy. For example, adding batteries to the vehicle to capture the power and then utilizing the power stored in the battery for other tasks. This can be counterproductive, however, due to the weight of the battery which in turn requires additional fuel to generate sufficient power for moving the vehicle under the added load.

It is therefore desired that an energy efficient system and be developed that makes use of excess energy for purposes of performing certain computations or computational tasks. It is further desired that such system and methods make use of excess energy that is already readily available.

### SUMMARY

In an example, network as disclosed herein comprise a parent system connected via data communication to a child system, wherein the child system is located at a source of behind-the-meter (BTM) energy to perform a computational task assigned to the child system by the parent system using the BTM energy. In an example, the network is configured to enable the child system to perform the computational task when the BTM energy available exceeds an amount for performing a primary task at the source of the BTM energy. In an example, the parent system communicates with the child system by wired or wireless data communication. In an example, the parent system is located remote from the source of the BTM energy. In an example, the parent system is located at a source of BTM energy that may be the same or different as the source of BTM energy where the child system is located. In an example, the network comprises more than one parent-child systems. In an example, the parent system provides a queue of computational tasks. In an example, the child system is a parent system to another child system. In an example, the BTM energy is provided by stationary and/or moving energy sources including and not limited the group including homes, energy farms, vehicles, human power, solar energy, hydro energy, wind energy, and combinations thereof In an example, the computational task is secondary to a primary function of the child.

In an example, a method of performing a computational task as disclosed herein comprises sending data from a parent system relating to a computational task to be performed, and receiving the data by a child system, wherein the child system is located at a source of behind-the-meter (BTM) energy. In an example, the method comprises monitoring the BTM energy by the child system to determine BTM energy availability. In an example, the method comprises performing the computational task when the BTM energy availability exceeds an amount beyond a primary function of the child system. In an example, the computational task is performed to balance an available BTM energy of the child.

In an example, a system for utilizing (BTM) energy for a secondary purpose as disclosed herein comprises performing a computational task for a network, wherein the network comprises a parent system connected via data communication to a child system, and wherein the child system is located at the source of the BTM energy and is configured to perform the computational task using the BTM energy. In an example system, the BTM energy is provided by the group including a home, a building, a vehicle, a human, and combinations thereof. In an example system, the BTM energy is provided by the group including regenerative braking, solar energy, hydro energy, wind energy, kinetic energy, thermal transfer, and combinations thereof. In an example, the system is configured to enable the child system to use the BTM energy to perform the computational task when the BTM energy exceeds an amount to perform a primary purpose of the system.

In various embodiments, systems, methods, and articles of manufacture (collectively, the “system”) for energy efficient distributed computing are disclosed.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for energy efficient distributed computing, in accordance with various exemplary embodiments;

FIG. 2 is a block diagram illustrating a platform of a system for efficient distributed computing, in accordance with various exemplary embodiments;

FIG. 3 is a block diagram illustrating a network environment of a system for efficient distributed computing, in accordance with various exemplary embodiments; and

FIG. 4 is a process of a system for efficient distributed computing in accordance with various exemplary embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, messages, data for storage, and the like in digital or any other form.

As used herein, “satisfy,” “meet,” “match,” “associated with”, or similar phrases may include an identical match, a partial match, meeting certain criteria, matching a subset of data, a correlation, satisfying certain criteria, a correspondence, an association, an algorithmic relationship, and/or the like. Similarly, as used herein, “authenticate” or similar terms may include an exact authentication, a partial authentication, authenticating a subset of data, a correspondence, satisfying certain criteria, an association, an algorithmic relationship, and/or the like.

Systems, methods, and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Systems and methods as disclosed herein for performing energy efficient computations or computational pasts rely on using excess energy that is available for example from vehicles. Though progress is being made, most attempts at capturing excess vehicle energy have not gained momentum or mass adoption. Challenges exist such as effectiveness and efficiency of energy captured, infrastructure and cost to capture the energy, additional weight imposed by regenerative equipment, usability of energy captured, etc. Perhaps one of the greatest hurdles for implementing methods to capture excess energy has been the question of what to do with the energy. Regenerative braking demonstrates the effectiveness of such a system in using the excess energy produced by the vehicle at the source of generation. However, there are limited tasks that can be performed at the point of excess energy availability in vehicles. Therefore, utilizing a similar model to that explained in the BTM energy station example we find a significant opportunity to utilize excess energy from vehicles for performing computations or computational tasks that have the benefit of effectiveness no matter where they are performed.

While supporting the effort of performing mobile computational tasks may have presented a challenge in the past, with the advancement in wireless communication technology and global network connectivity in recent years there exists an opportunity to implement such a model. Initiatives by companies like Starlink and Viasat are implementing technology via satellite communication that will enable global connectivity. These technologies have demonstrated speeds in the most remote of locations well exceeding 25 megabits per second, which would enable efficient data transfer for most computational processes.

Thus, systems and methods as disclosed herein address the growing demand for reduction of carbon footprint, relying on the abundance of excess energy from vehicles, and advancements in connectivity that enable the performance of remote computational tasks on a global scale.

Systems and methods as disclosed herein are configured to enable a computations task, e.g., in the form of a sub-operation or the like, to be performed at the source of energy waste (i.e., at the source where readily available excess energy exists), and where a resulting output can be sent via data to a parent system to complete all or part of a master-operation.

An example of such an application where the systems and methods as disclosed herein may be used includes the computations or computational tasks associates with bitcoin mining. In such application, Bitcoin miners perform hash to determine the correct 64-digit hexadecimal number to create the block of transactions. Available miners call on the Bitcoin block chain for the information to perform the mining operation. The data transfer required for the mining process is relatively small, but the computational task associated with the bitcoin mining is overwhelming and energy-rich/intensive. In an example embodiment, the systems and methods disclosed herein may be used, wherein a parent system can be used to manage the bitcoin mining process, and other less energy intensive computations or computational tasks may be portioned out to be performed to one or more, e.g., dozens, hundreds or thousands of sub-operations (children).

These operations can be mobile vehicles that remain connected to the parent and/or queue of tasks via data connection. As a child becomes available with excess energy to perform the computation, it can pull from the parent and/or queue and begin performing the computations, sending the results back through the network. The energy availability of the child is continuously monitored either by the parent or by the child independently. Depending on the cost of energy or lack thereof in the case of using excess energy, the network can assess where the tasks are best performed and assign them accordingly.

For example, a child operation may have some excess energy available but not enough to fully perform a computation and thus may require use of fossil fuel to generate the remaining necessary energy and therefore the overall computation may result in less energy consumption as opposed to being performed by a child that is fully available and powered by conventional electricity. In this example, the child may be a passenger vehicle commuting to work wherein the energy fluctuations between stop and go traffic provide a varying degree of excess energy availability.

Alternatively, the child may not have enough excess energy and therefore is unavailable to participate in the computations. This could be a vehicle similarly commuting but is already drawing from the excess energy to power other devices in the vehicle. In another example, a child may have an abundance of energy available and can take a larger portion of the available computational tasks presented by the parent/queue. This could be a larger commercial vehicle, such as a fleet vehicle used for refrigeration or the like, traveling long distances to warehouses without a load to draw the energy locally.

The computation equipment can draw energy from a variety of methods as generated by the vehicle. As mentioned in the background, the energy could be sourced from a regenerative braking operation wherein the vehicle does not require the energy itself for travel or perhaps the reward received from performing the computation is greater than the cost of electricity to power the vehicle.

In another example, the energy can be collected from the electrical system as distributed by the alternator. It is well known that the alternator distributes DC current to the vehicle systems and in many cases the energy availability exceeds the demand of the vehicle; thus creating excess energy for use. In addition, there exists an opportunity to tap the AC current generator prior to the alternator's regulator to power the computation equipment.

In either case, determining the availability of energy from the vehicle would benefit from a regulator device which could assess the energy generated vs. Energy demand from the vehicle for normal operations and distribute the excess accordingly for the computation equipment. This regulator could provide visibility to the energy availability for communication from the child to the parent or simply by the child itself to determine which computations should be performed, if any.

These computational tasks can be operating continuously or intermittently and this is the benefit of the system which will therefore continuously consume the excess data efficiently and only rely on what is available rather than needing to rely on further generation of energy (though this could still be done). These overall systems can exist globally and function at any time as there is no dependence on geographical location or any one child operation. Data transfer is efficient and there is no loss as can be experienced with the transfer of solar, wind, electrical, etc. energy. Data carries no weight and therefore the transfer does not require the consumption of significant energy in proportion to the value that can be derived from the data. Data can be transferred and used instantaneously, not requiring significant logistical planning or in the case of wireless communication, a physical connection between operations to achieve a transfer.

The term vehicle is to be interpreted loosely and though the invention mentions a few examples, they are not to be construed as limiting options for the invention. Vehicles can include but not be limited to: cars, motorcycles, scooters, trucks, agricultural and mining vehicles, lawn mowers, bicycles, airplanes, gliders, trains, boats, and beyond.

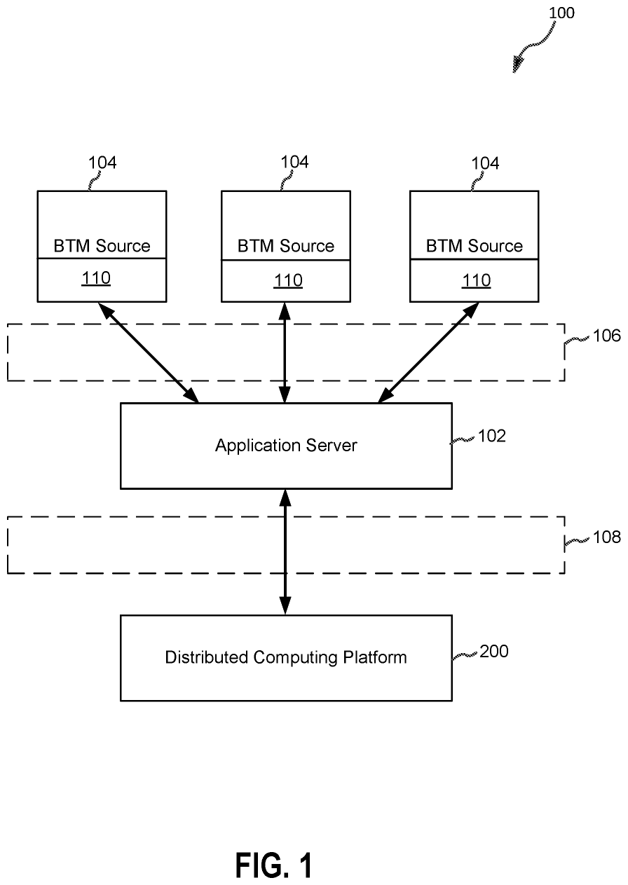

In various embodiments, and with reference to FIG. 1, a system 100 for energy efficient computation is depicted. System 100 may include various computing devices, software modules, networks, hardware modules, and data structures in communication with one another. System 100 may also contemplate uses in association with web services, utility computing, pervasive and individualized computing, security and identity solutions, autonomic computing, cloud computing, commodity computing, mobility and wireless solutions, open source, biometrics, blockchain networks, grid computing and/or mesh computing. System 100 may comprise an application server 102, a Behind the Meter (BTM) source 104, and a distributed computing platform 200. Any of these components may be outsourced and/or be in communication with the application server 102 and/or service 200 via a network such as, for example a first network 106 and a second network 108.

System 100 may be computer based, and may comprise a processor, a tangible non-transitory computer-readable memory, and/or a network interface, along with other suitable system software and hardware components. Instructions stored on the tangible non-transitory memory may allow system 100 to perform various functions, as described herein. In various embodiments, the application server 102 and/or platform 200 may be configured as a central network element or hub to access various systems, engines, and components of system 100. The application server 102 may comprise a network (e.g., network 106), a computer-based system, and/or software components configured to provide an access point to various systems, engines, and components of system 100. The application server 102 may be in operative and/or electronic communication with user devices 104 via the first network 106 and the service 200 via the second network 108. In this regard, the application server 102 may allow communication from the BTM sources 104 to systems, engines, and components of system 100 (such as, for example, service 200). In various embodiments, the application server 102 may receive data, commands and/or metadata from the BTM sources 104 and may pass data and replies to the BTM sources 104.

In various embodiments, application server 102 may include one or more computing devices described above, rack mounted servers, and/or virtual machines providing load balancing, application services, web services, data query services, data transfer services, reverse proxy services, or otherwise facilitating the delivery and receipt of data across networks (106, 108).

In various embodiments, a BTM source may comprise a point of excess energy availability such as, for example, a renewable energy farm, a vehicle, a solar powered home, a windmill, a generator, a heat pump, and/or the like. In various embodiments, a BTM source 104 may comprise software and/or hardware in communication with the system 100 via a network (e.g. network 106) comprising hardware and/or software configured to allow a user (e.g., a distributed processor) and/or the like, access to the application server 102. The BTM source 104 may comprise any suitable device that is configured to allow the BTM source to communicate with a network and the system 100.

In various embodiments, the BTM source 104 may comprise a child module 110 configured to monitor the BTM source 104 for excess energy production and to extract energy from the BTM source for use in computing operations. In various embodiments, the child module 110 may comprise hardware and/or software installed on the BTM source 104. The child module 110 may be configured to communicate with the application server 102 and/or platform 200 to receive a queue of computational tasks. The child module 110 may comprise hardware and/or software configured to execute computing tasks based on the received queue of computational tasks and to transmit the results of the tasks to the platform 200. A child module 110 may be installed on the BTM source 104 via, for example, a hardware module, download, physical media, or an app store, for example. In various embodiments, the child module 110 may utilize the development code base provided for use with an operating system of the BTM source 110 and may be capable of performing system calls to manipulate data stored on the BTM source 104 to perform computing operations and communicate with application server 102.

In various embodiments, the child module 110 running on the BTM source 104 may be in communication with the application server 102 to support real-time updates. For example, data pertaining to the system 200 may synchronize across the various BTM sources 104 used by any number of users interacting with the application server 102 and/or platform 200. In this regard, the application server 102 may serve data from platform 200 to each of the BTM sources 104 and may serve commands and data from the BTM sources 104 (e.g., via the child module 110) to the platform 200. In various embodiments, application server 102 may apply access permissions to restrict the data transmitted between the networks (106, 108) and/or the various components of system 100.

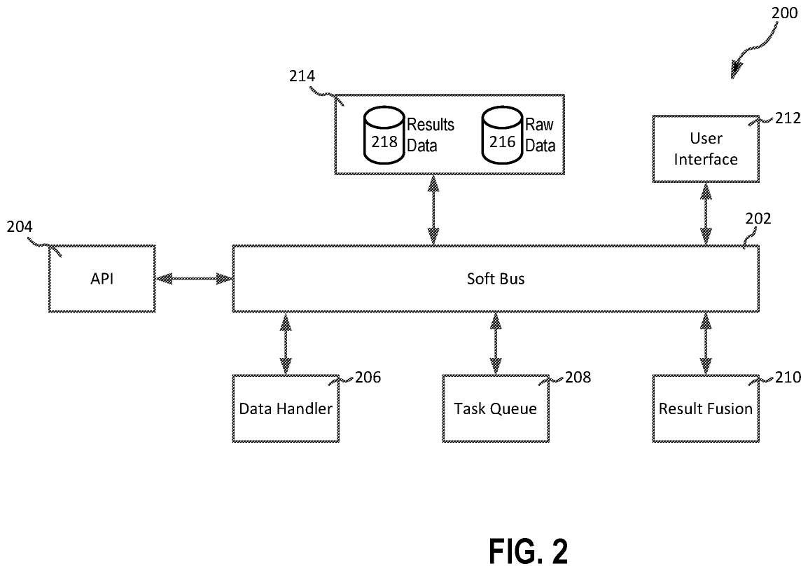

With additional reference to FIG. 2, a block diagram of a distributed computing platform 200 of system 100 is illustrated in accordance with various embodiments. Platform 200 may comprise a software bus architecture 202, an application programming interface (i.e., API module 204), a data handler 206 module, a task queue module 208, a stream fusion module 210, a user interface module 212, and a database module 214.

In various embodiments, API module 204 may be configured to provide a programmatic interface to any of the set of system 100 or platform 200 services, components, modules, and/or engines.

In various embodiments the data handler 206 is configured to capture, transmit, and receive data from one or more of the BTM sources 104 for use by the various systems, engines, and components of platform 200. In various embodiments data, may be real-time data feeds. The data handler may be capable of integrating with a variety of data sources.

In various embodiments, the task queue module 208 may be configured to collect and process computing requests from platform users into a plurality of child tasks for distribution to the BTM sources 104.

In various embodiments, the result fusion module 210 comprises engines configured to synchronize and compile the results of the distributed computing tasks assigned to the BTM sources.

In various embodiments, the user interface module 212 may provide outputs from the platform 200 to platform users. In various embodiments, the user interface module 212 may provide outputs through channels such as, for example, a web based application or a native application of a mobile device. The user interface may enable on demand viewing of archived results data 218.

In various embodiments, the database module 214 may include any number of data structures or data elements such as, for example, raw data 216 and results data 218. Database module 214 may be configured to maintain raw data 216 such as, for example, pre-processing data for distribution to the BTM sources. Database module 214 may be configured to maintain results data 218 such, for example, data transmitted to the BTM sources 104 which has been processed via the child module 110 and returned to the platform 200.

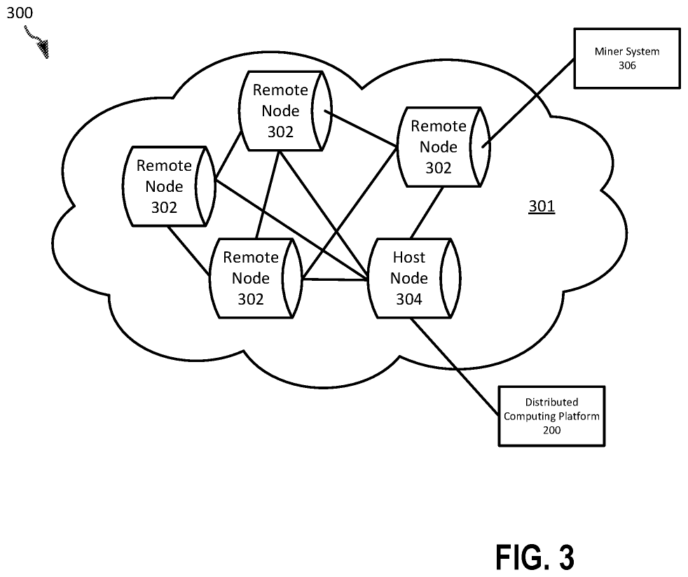

In various embodiments, and with additional reference to FIG. 3, a network environment 300 for operating system 100 is illustrated. Environment 300 includes a distributed ledger network such as a blockchain network 301 which is in communication with a miner system 306 and the distributed computing platform 200.

Network environment 300 may comprise a blockchain network 301 configured to maintain a blockchain, in accordance with various embodiments. Blockchain network 301 may be a peer-to-peer network that is private, federated, and/or public in nature (e.g., the ETHEREUM® system, the Bitcoin system, the HYPERLEDGER® Fabric system, etc.). Federated and private networks may offer improved control over the content of the blockchain and public networks may leverage the cumulative computing power of the network to improve security. Blockchain network 101 may comprise various blockchain nodes (e.g., consensus participants such as remote nodes 302 and host node 304) in electronic communication with each other, as discussed further herein. Each blockchain node may comprise a computing device configured to write blocks to the blockchain and validate blocks of the blockchain. The computing devices may take the form of a computer or processor, or a set of computers and/or processors or application specific integrated circuits (ASICs), although other types of computing units or systems may also be used. Exemplary computing devices include servers, pooled servers, laptops, notebooks, hand held computers, personal digital assistants, cellular phones, smart phones (e.g., an IPHONE® device, a BLACKBERRY® device, an ANDROID® device, etc.), tablets, wearables (e.g., smart watches and smart glasses), Internet of Things (IOT) devices, or any other device capable of receiving data over network. Each computing device may run applications to interact with blockchain network 301, communicate with other devices, perform crypto operations, and otherwise operate within environment 300 and system 100. Computing devices may run a client application that can be a thin client (web), hybrid (i.e. web and native, such as iOS and ANDROID® systems), or native application to make API calls to interact with the blockchain, such as a web3 API compatible with blockchain databases maintained by the ETHEREUM® system.

The blockchain may be based on any blockchain technology such as, for example, ETHEREUM®, OPENCHAIN®, Chain Open Standard technology, HYPERLEDGER® Fabric, CORDA®, Connect™, Sawtooth™, etc. The blockchain may comprise a system of blocks containing data that are interconnected by reference to the previous block. Each block may link to the previous block and may include a timestamp. Data can be added to the blockchain by establishing consensus between the blockchain nodes based on proof of work, proof of stake, practical byzantine fault tolerance, delegated proof of stake, or other suitable consensus algorithms. For example, specialized computing devices such as miner system 306 may be connected to blockchain network 301 to perform computationally intensive tasks such as validating the blocks of the blockchain by proof of work. In various embodiments, platform 200 may be in communication with host node 304 and may be assigned one or more computing tasks such as, for example, block validation and timestamp generation by the host node 304. As discussed above, platform 200 may break up and distribute the computing task to the plurality of BTM sources 104 and/or child modules 110. In this regard, system 100 may tend to increase the efficiency and utility of the network environment 300 by reducing energy consumption and processing overhead.

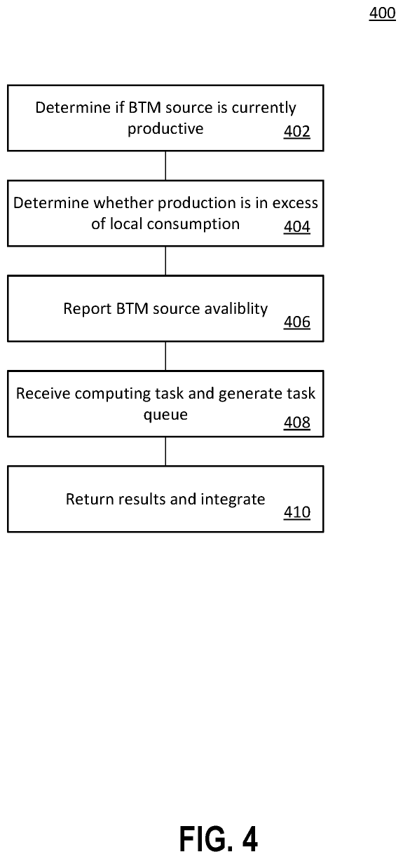

In various embodiments and with additional reference to FIG. 4, a process 400 for assigning computational tasks in system 100 is illustrated. The system may determine if a BTM source 104 is currently producing energy (step 402). For example, child module 110 may comprise one or more sensors coupled to BTM energy producing components such as a regenerative braking mechanism, a DC current source, an AC current source, and/or the like. The system may determine based on the sensor input whether current is flowing from the energy producing component. The system may determine whether energy production at the BTM source 104 is in excess of local energy consumption (step 404). For example, the child module 104 may compare the output of a home photovoltaic array to current draw of a battery storage bank and, where the draw is less than the available output of the photovoltaic array the system may determine energy production at the BTM source to be in excess of local energy consumption. The system may report the availability of BTM sources (step 406). For example, the child module 100 may transmit a notification to the platform 200 that the BTM source 104 is available in response to determining the BTM source 104 is active and energy product exceeds local consumption. The system may receive a computing task and generate a task queue (step 408). For example, the system may receive a computing task via the user interface 212 and/or the API module 204. The system may subdivide the computing task and generate a task queue via task queue module 208 for distribution to the BTM sources 104. The system may distribute the task que and related data to be processed via the data handler module 206. The system may receive the processed results of the sub-tasks and integrate the results to generate a result for the computing task (step 410). For example, the child module 110 may draw energy from the available excess energy of the BTM source 104 to perform computing operations based on the task queue and the received data. The child module 110 may communicate the results to the platform 200 which may integrate the sub-task results via the result fusion module 210 to return a result for the assigned computing task. In this regard, the system may tend to increase the utility of computing by enabling computing operations to be conducted at grid edge locations.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEB SPHERE® MQTM (formerly MQSeries) by IBM®, Inc. (Armonk, NY) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE software, SYBASE software, INFORMIX software, MYSQL software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

In various embodiments, the server may include application servers (e.g., WEBSPHERE®, WEBLOGIC®, JBOSS®, POSTGRES PLUS ADVANCED SERVER®, etc.). In various embodiments, the server may include web servers (e.g., Apache, IIS, GOOGLE® Web Server, SUN JAVA® System Web Server, JAVA® Virtual Machine running on LINUX® or WINDOWS® operating systems).

A web client includes any device or software which communicates via any network, such as, for example any device or software discussed herein. The web client may include internet browsing software installed within a computing unit or system to conduct online transactions and/or communications. These computing units or systems may take the form of a computer or set of computers, although other types of computing units or systems may be used, including personal computers, laptops, notebooks, tablets, smart phones, cellular phones, personal digital assistants, servers, pooled servers, mainframe computers, distributed computing clusters, kiosks, terminals, point of sale (POS) devices or terminals, televisions, or any other device capable of receiving data over a network. The web client may include an operating system (e.g., WINDOWS®, WINDOWS MOBILE® operating systems, UNIX® operating system, LINUX® operating systems, APPLE® Os® operating systems, etc.) as well as various conventional support software and drivers typically associated with computers. The web-client may also run MICROSOFT® INTERNET EXPLORER® software, MOZILLA® FIREFOX® software, GOOGLE CHROME™ software, APPLE® SAFARI® software, or any other of the myriad software packages available for browsing the internet.

As those skilled in the art will appreciate, the web client may or may not be in direct contact with the server (e.g., application server, web server, etc., as discussed herein). For example, the web client may access the services of the server through another server and/or hardware component, which may have a direct or indirect connection to an internet server. For example, the web client may communicate with the server via a load balancer. In various embodiments, web client access is through a network or the internet through a commercially-available web-browser software package. In that regard, the web client may be in a home or business environment with access to the network or the internet. The web client may implement security protocols such as Secure Sockets Layer (SSL) and Transport Layer Security (TLS). A web client may implement several application layer protocols including HTTP, HTTPS, FTP, and SFTP.

The various system components may be independently, separately, or collectively suitably coupled to the network via data links which includes, for example, a connection to an Internet Service Provider (ISP) over the local loop as is typically used in connection with standard modem communication, cable modem, DISH NETWORK®, ISDN, Digital Subscriber Line (DSL), or various wireless communication methods. It is noted that the network may be implemented as other types of networks, such as an interactive television (ITV) network. Moreover, the system contemplates the use, sale, or distribution of any goods, services, or information over any network having similar functionality described herein.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT® programs, active server pages (ASP), common gateway interface scripts (CGI), extensible markup language (XML), dynamic HTML, cascading style sheets (CSS), AJAX (Asynchronous JAVASCRIPT And XML) programs, helper applications, plug-ins, and the like. A server may include a web service that receives a request from a web server, the request including a URL and an IP address (192.168.1.1). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

The computing unit of the web client may be further equipped with an internet browser connected to the internet or an intranet using standard dial-up, cable, DSL, or any other internet protocol known in the art. Transactions originating at a web client may pass through a firewall in order to prevent unauthorized access from users of other networks. Further, additional firewalls may be deployed between the varying components of CMS to further enhance security.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

What is claimed is:

1. A network comprising a parent system connected via data communication to a child system, wherein the child system is located at a source of behind-the-meter (BTM) energy to perform a computational task assigned to the child system by the parent system using the BTM energy.

2. The network of claim 1, wherein network is configured to enable the child system to perform the computational task when the BTM energy available exceeds an amount for performing a primary task at the source of the BTM energy.

3. The network of claim 1, wherein the parent system communicates with the child system by wired or wireless data communication.

4. The network of claim 1, wherein the parent system is located remote from the source of the BTM energy.

5. The network of claim 1, wherein the parent system is located at a source of BTM energy that may be the same or different as the source of BTM energy where the child system is located.

6. The network of claim 1 comprising more than one parent-child systems.

7. The network of claim 1, wherein the parent system provides a queue of computational tasks.

8. The network of claim 1, wherein the child system is a parent system to another child system.

9. The network of claim 1, wherein the BTM energy is provided by stationary and/or moving energy sources.

10. The network of claim 9, wherein the energy is provided by the group including homes, energy farms, vehicles, human power, solar energy, hydro energy, wind energy, and combinations thereof

11. The network of claim 1, wherein the computational task is secondary to a primary function of the child.

12. A method of performing a computational task comprising:
sending data from a parent system relating to a computational task to be performed; and
receiving the data by a child system, wherein the child system is located at a source of behind-the-meter (BTM) energy.

13. The method of claim 12, comprising monitoring the BTM energy by the child system to determine BTM energy availability.

14. The method of claim 12, comprising performing the computational task when the BTM energy availability exceeds an amount beyond a primary function of the child system.

15. The method of claim 12, wherein the computational task is performed to balance an available BTM energy of the child.

16. A system utilizing behind-the-meter (BTM) energy for a secondary purpose comprising performing a computational task for a network, wherein the network comprises a parent system connected via data communication to a child system, wherein the child system is located at the source of the BTM energy and is configured to perform the computational task using the BTM energy.

17. The system of claim 16, wherein the BTM energy is provided by the group including a home, a building, a vehicle, a human, and combinations thereof.

18. The system of claim 16, wherein the BTM energy is provided by the group including regenerative braking, solar energy, hydro energy, wind energy, kinetic energy, thermal transfer, and combinations thereof.

19. The system of claim 16, wherein the system is configured to enable the child system to use the BTM energy to perform the computational task when the BTM energy exceeds an amount to perform a primary purpose of the system.
